(19) United States
(12) Patent Application Publication
(10) Pub. No.: US 2019/0366633 A1
(43) Pub. Date: Dec. 5, 2019

(54) PRINT MATERIAL CONTAINER RECEPTACLE

(71) Applicant: HEWLETT-PACKARD DEVELOPMENT COMPANY, L.P., Houston, TX (US)

(72) Inventors: Joan SANJUAN, Sant Cugat del Valles (ES); Vincent GRANADOS ASENSIO, Sant Cugat del Valles (ES)

(73) Assignee: HEWLETT-PACKARD DEVELOPMENT COMPANY, L.P., Houston, TX (US)

(21) Appl. No.: 16/089,135

(22) PCT Filed: Feb. 27, 2017
(86) PCT No.: PCT/US2017/019725

§ 371 Date: Sep. 27, 2018

(51) Int. Cl. B29C 64/255; B33Y 30/00; B41J 2/175

(52) U.S. Cl. CPC B29C 64/255; B41J 2/1752; B41J 2/17553; B33Y 30/00

(57) ABSTRACT

It is disclosed a printing agent container receptacle that can receive printing agent containers of different sizes. The printing agent container receptacle comprising an actuator that, upon receipt of a longitudinal insertion force on the container defines a stop position of the printing agent container.

### BACKGROUND

The material to be used in 3D or 2D printing processes, either build material or printing liquid, may be disposed in containers of different sizes and materials depending on the material contained, the printer to use and the printing process itself, for example, if the printing environment is mass production printing or prototyping.

In the foregoing description the print material can be either build material and/or printing liquid for 2D or 3D printing processes.

Build material can be, for example, powder, short fiber build materials, plastics or resins.

### BRIEF DESCRIPTION OF THE DRAWINGS

FIG. 1 is a perspective view of an example of print container receptacle with a container disposed therein.

FIG. 2A is a side view of a cross section of a print container receptacle with a container of a first size located therein.

FIG. 2B is a side view of a cross section of print container receptacle with a container of a second larger size located therein.

FIG. 3 is a schematic drawing of an example of print material container receptacle.

### DETAILED DESCRIPTION

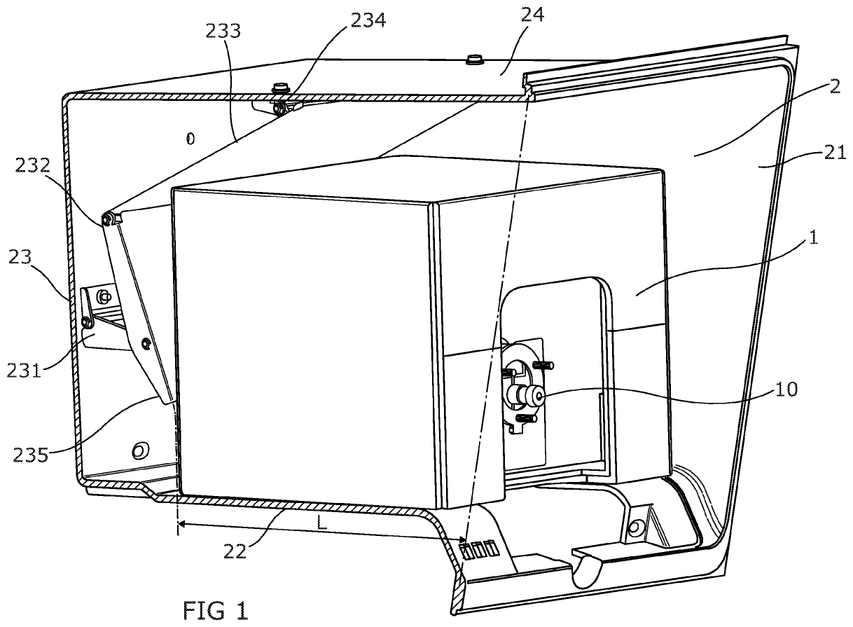

FIG. 1 shows a receptacle 2 adapted to receive a printing agent container 1, such receptacle 2 comprising means for receiving the container that passes through an opening 21 and being displaced in a longitudinal direction upon realization of an insertion force. As shown in FIG. 1, a base plate 22 is disposed to receive the container 1 so that the container may be inserted through the opening 21 by sliding it over the base plate 22 in a direction longitudinal to the container 1 and the receptacle 2 by means of a longitudinal insertion force, for example, exerted by a user.

In alternative solutions, at least one rail on a side plate or the top plate 24 of the receptacle 2 can be used for receiving the printing agent container 1.

FIG. 1 additionally shows a blocker that defines a stop point 235 adapted to stop the container 1 thereby preventing the movement of the container 1 further than a determined longitudinal distance L from the inlet 1. The example of FIG. 1 is particularly useful in applications in which the receptacle 1 is to receive printing agent containers 1 of different volume or, at least, printing agent containers 1 with a different length, and a different width or height. In the example of FIG. 1 an actuator 233 is adapted to use the size of the printing agent container 1 (either the height or the width) as a trigger for adapting the position of the blocker. In an example, the stop point 235 of the blocker is movable so that the blocking mechanism provides the receptacle 2 the ability to stop a printing agent container 1 at different distances from the opening thereby allowing, for example, that the outlet 10 on the front face of the printing agent container 1 is substantially at the same position notwithstanding the length of the printing agent container 1 thereby allowing for easier automation and, in case of manual operations, improving the ergonomics of any connections to the container.

The example receptacle of FIG. 1 is an enclosure comprising an opening 21 on its front face, a pair of side plates, a back plate 23 opposite to the opening 21, a top plate 24 and a base plate 22. The receptacle of FIG. 1 also comprises an actuator 233 located within the receptacle and mechanically coupled to a blocker 232 which defines a stop point 235. The receptacle further comprises an arm 231 rotatably attached to the back plate which is coupled to move the blocker 232 from a first position to a second position.

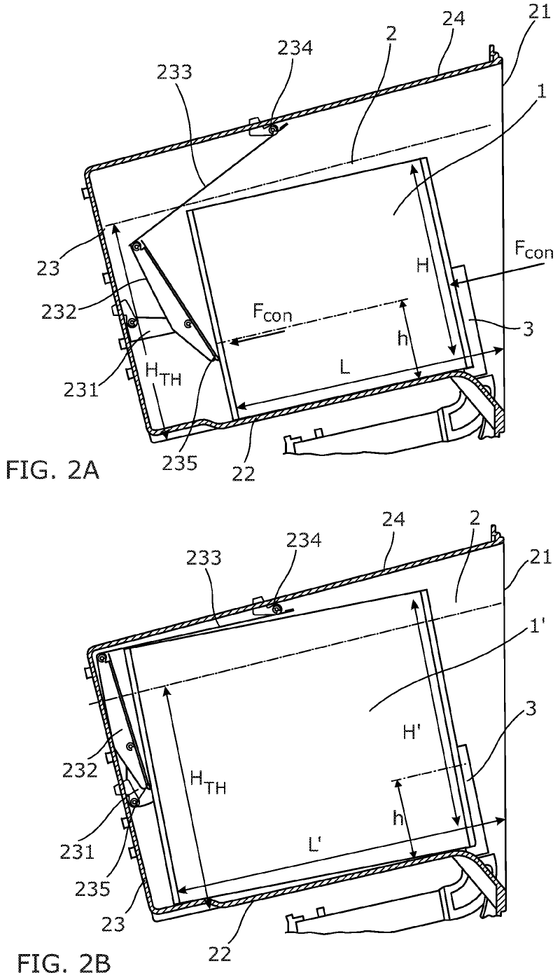

FIG. 2A shows the example of FIG. 1 wherein a printing agent container having a determined length, width and height is inserted through the opening 21 by sliding it over the base plate 22 using an insertion force.

The printing agent container shown in FIG. 2A is a container of a first size that the receptacle 1 is adapted to receive, therefore its length as well as one of the width or the height has a smaller dimension than the printing agent container with a second larger size which the receptacle 1 is also adapted to receive. It should be noted that the receptacle 1 shown in FIG. 2A is representative of any container wherein the height/width of the container s below the threshold width/height.

In this example, the actuator 233 may modify the position of the blocker 232 depending on the height of the printing agent container 1 so that for every container 1 with a height below the threshold height H_{TH} (as is the case for the first size of container) the blocker 232 is located at a first position and for containers with a height over the threshold height H_{TH}, such as the second container 1′ of FIG. 2B, the blocker 232 is moved to a second position by means of the actuator 233. In another example, a 90° rotation of the blocker 232 and the arm 231 would allow the actuator to determine the stop position 235 depending on the width of the container.

Given that the container 1 has a height H that does not exceed the threshold height H_{TH} defined by the actuator 233, the printing agent container 1 is stopped by the blocker 232, specifically, on the stop position 235. Even though the arm 231 is rotatably attached to the back plate 23, it is locked at a maximum angle so that it cannot further rotate in the clockwise direction because of its own blocking with the back plate 23. The locking of the further rotation of the arm 231, allows the blocker 232 to stop the container at a first distance L from the opening 21. This same principle would apply to an arm rotatably attached to one of the side plates, therefore, the arm can be attached to any of the walls of the receptacle, especially, on the back plate 23 or a side plate.

In the example of FIG. 2A the actuator 233 is an inclined plate hinged to the top plate 24 and rotatably attached to the blocker 232. The joint between the inclined plate and the blocker may be a longitudinally fixed joint (rotation only joint, with no displacement) so that the rotation of the inclined plate causes a longitudinal and a transversal displacement on the blocker 232 within the receptacle 2.

Also, in this figure the threshold height H_{TH} is defined by the intersection between a plane perpendicular to the longitudinal direction at the first longitudinal distance and the inclined surface. In this case the container 1 has a height which is smaller than the threshold height and, therefore, the blocker 232 is located at a first position wherein the blocker stops the printing agent container at a first distance L from the opening

Another feature of this example is that the blocker 232 is configured to locate the stop position 235, i.e., the position in which, upon insertion of a container is stopped, at substantially the same height as the outlet 10 of the printing agent container 1. This feature is particularly relevant because, given that the internal dimensions of the receptacle substantially exceed the dimensions of the container 1, a connecting force F_{con} exerted on the container by a connector 3 may cause the container 1 to tilt if, e.g., the stop position 235 is on the base plate, wherein the container 1 may accidentally act on the actuator 233 or cause an incorrect connection of the outlet 10. In the example of FIG. 2A, the connecting force F_{con} acts at the same height of the stop position 235 thereby avoiding undesirable rotations of the container 1.

A container with a height over the threshold height H_{TH} would act on the actuator and may modify the position of the blocker 232 as will be shown below with reference to FIG. 2B.

In FIG. 2B a second container 1′ with a second larger height H′is shown, In this case, the height H′ is larger than the height H of the smaller container and, also, larger than the threshold height H_{TH}.

The insertion force exerted on the second container 1′, which may be a substantially a longitudinal force, acts on the actuator 233 before reaching the first distance L from the opening 21 wherein the blocker 232 is located, therefore, the container acts on the actuator 233 and moves the blocker 232 to a second position wherein the printing agent container is stopped at a distance from the opening further than the first distance L. In this particular case, the actuator 233 moves, by means of the insertion force on the second container 1′, the blocker 232 to a second position by inducing a rotational force on the arm 231. It should be noted that the blocker 232 itself can also be used to stop the container at this position or, alternatively, the stopping of the second container 1′ can be performed by a different stop surface such as, e.g., the back plate 23 or the arm 231

In the example of FIG. 2B, the insertion force on the container 1′ exerts a force on the actuator 233 wherein the insertion force, which can be a longitudinal insertion force, is converted, by means of the actuator 233 into a counterclockwise rotational force on the arm 232, the arm moves the blocker 232 from a first position to a second position and, therefore, the stop position 235 is moved with at least a component in the longitudinal direction of the receptacle 2 allowing the receptacle to be inserted a distance larger than the first distance thereby defining a second distance L′. It should be noted that the stop position, in this case, has also moved with a vertical component but such movement is not relevant as for the functioning of the stop mechanism. Alternatively, a stop mechanism could be designed wherein no vertical component occurs and the movement of the stop position is in a direction substantially parallel to the insertion force and/or the receptacle's longitudinal direction.

Also, in this example, the blocker's position may be biased to the first longitudinal distance. This can be accomplished, for example, by using elastic means on any of the hinged or rotatable connections or by making the inclined plate and/or the arm heavy enough so that, by means of gravity, the default position is the first position, i.e., the position wherein the blocker 232 stops the printing agent container at the smallest distance from the opening 21.

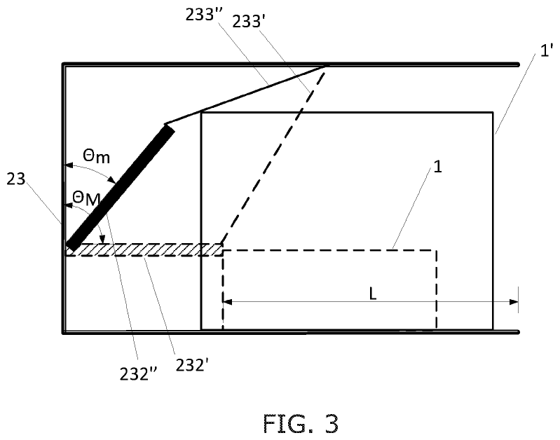

FIG. 3 is a schematic drawing to show the operating principle of a receptacle for printing agent containers that is adaptable for different sizes. In the example of FIG. 3 it can be seen that the arm 232 while at the first arm position 232′ provides for a stop of the container 1 at a first distance L from the opening 21. The arm 232 would provide for a stop to be put in place for every container with a height below the threshold height at the first distance L.

Also, a second container 1′, which is representative of a container with a height exceeding the threshold height, upon action of an insertion force would act on the actuator 233 so that it moves from the first actuator position 233′ to a second actuator position 233″ thereby moving the arm to a second arm position 232″ thus allowing the container to stop at a distance which is larger than the first distance L.

The arm 232 is rotatably attached to the back plate 23, for example, by a hinged connection. This hinged connection may be locked so that the connection does not exceed a maximum angle OM, for example by blocking the arm against the back plate. Likewise, the hinged connection may be set so that the connection does not decrease below a minimum angle Θₘ thereby defining the stop distance for the second container 1′. Also, from this figure can be inferred that, by means of gravity, when no container is on the receptacle the arm will return to the first arm position 232′.

In essence, a printing agent container receptacle is disclosed that comprises an input opening to receive a printing agent container in a longitudinal direction wherein the receptacle comprises a blocker movable between a first position wherein the blocker stops the printing agent container at a first distance from the opening; and a second position wherein the printing agent container stops in a position further than the first distance wherein the receptacle further comprises an actuator to move the blocker from the first position to the second position upon receipt of a longitudinal force by insertion of the printing agent container into the printing agent container receptacle. The actuator moves the blocker from the first position to the second position upon receipt of an insertion force by a container exceeding a threshold width or height. In order for the actuator to receive the insertion force only by containers exceeding a threshold width or height, the actuator can itself be located at the threshold height.

In an example, the blocker is biased to the first position, this can be performed either by gravity or by using elastic means, for example, on hinged or rotatable connections.

In another example, the receptacle comprises a wall and wherein the blocker comprises an arm that is extendable from the wall. The wall can be a plate of the receptacle, such as the back plate or a side plate, while the container is configured to be inserted parallel to a base plate being the bae plate substantially perpendicular to both, the side plates and the back plate.

As explained above, the blocker may move from first position to the second position by a moving with a component in the direction of the longitudinal force. So that in the first position it stops the container at a first distance from the opening and, on the second position it allows for the container to stop at a distance larger than the first distance.

The actuator may comprise a rotatable arm attached to a wall, for example, the top plate wherein the longitudinal force induces a rotational force on the arm. The arm may be hinged to another wall and the hinge may also locked at a maximum or a minimum angle defining the first position and the actuator inducing, upon receipt of, for example, an insertion force, a rotational movement on the hinge to modify the hinge's angle when moving the blocker 232 from the first position to the second position. In an example, the hinge is locked at a maximum angle and the actuator decreases the angle of the hinge, nonetheless, the hinge can be equally locked at a minimum angle and, upon receipt of the insertion force, the actuator may increase the aperture angle of the hinge.

Also, the actuator can comprise a surface angled with respect to the longitudinal direction of the receptacle so that the inclined surface defines the threshold height and/or width. In particular, the actuator may be located at a threshold width/height so that it moves the actuator from the first position to the second position by containers that exceed the threshold width and/or height being the threshold height located, for example, at the point of the surface wherein a plane perpendicular to the longitudinal direction at the first longitudinal distance intersects the inclined surface. Furthermore, the actuator may be rotatably attached to a top plate parallel to the upper surface of the printing agent container.

It is further disclosed a printing agent container receptacle adapted to receive printing agent containers of different sizes wherein the printing agent container receptacle comprises an actuator that upon receipt of a longitudinal insertion force by the container defines a stop position of the printing agent container. The stop position is determined by a blocker movable between a first position, wherein the blocker stops the printing agent container at a first distance from the opening, and a second position wherein the printing agent container stops in a position further than the first distance.

The actuator is, for example, located in a position wherein the actuator receives the longitudinal insertion force when the container exceeds a threshold width or height being the stop position defined, for instance, by an arm movable upon receipt of the longitudinal insertion force with at least a component in the longitudinal direction defined by the insertion force.

Furthermore, a method for receiving printing agent containers of different sizes in a receptacle wherein the receptacle comprises: an actuator and a blocker movable between: a first position wherein the blocker stops the printing agent container at a first distance from the opening; and a second position wherein the printing agent container stops in a position further from the opening than the first distance; wherein the method comprises detecting the height of a container and, if the height of the container exceeds a threshold height moving the blocker from the first position to the second position. The detecting of the height of the container may performed, for example, by positioning the actuator at the threshold height

One of the potential uses of the printing agent container receptacle described above may be a 3D printing system comprising a printing agent container receptacle that comprises an input opening to receive a printing agent container in a longitudinal direction wherein the receptacle comprises a blocker movable between: a first position wherein the blocker stops the printing agent container at a first distance from the opening; and a second position wherein the printing agent container stops in a position further from the opening than the first distance; wherein the receptacle further comprises an actuator to move the blocker from the first position to the second position upon receipt of a longitudinal force by insertion of the printing agent container into the printing agent container receptacle

1. A printing agent container receptacle that comprises an input opening to receive a printing agent container in a longitudinal direction wherein the receptacle comprises and blocker movable between:
A first position wherein the blocker stops the printing agent container at a first distance from the opening; and
a second position wherein the printing agent container stops in a position further from the opening than the first distance;
wherein the receptacle further comprises an actuator to move the blocker from the first position to the second position upon receipt of an insertion force of printing agent containers exceeding a threshold width or height into the printing agent container receptacle.

2. A printing agent container receptacle according to claim 1, wherein the blocker is biased to the first position.

3. A printing agent container receptacle according to claim 1, the receptacle comprising a wall and wherein the blocker comprises an arm that is extendable from the wall.

4. A printing agent container receptacle according to claim 1, wherein the blocker moves from first position to the second position with a component in the direction of the longitudinal force.

5. A printing agent container receptacle according to claim 4, wherein the actuator comprises a rotatable arm attached to a wall wherein the longitudinal force induces a rotational force on the arm.

6. A printing agent container receptacle according to claim 5, wherein the arm is hinged to the wall and wherein the hinge is locked at a maximum angle defining the first position and the actuator induces a rotational movement on the hinge to decrease the hinge's angle when moving the blocker from the first position to the second position.

7. A printing agent container receptacle according to claim 1, wherein the actuator comprises a surface angled with respect to the longitudinal direction of the receptacle so that the surface defines the threshold height and/or width.

8. A printing agent container receptacle according to claim 1 wherein the actuator is located at a threshold width/height so that it moves the actuator from the first position to the second position by containers that exceed the threshold width and/or height.

9. A printing agent container receptacle according to claim 8 wherein the threshold height is located at the point of the surface wherein a plane perpendicular to the longitudinal direction at the first longitudinal distance intersects the inclined surface.

10. A printing agent container receptacle adapted to receive printing agent containers of different sizes wherein the printing agent container receptacle comprises an actuator that upon receipt of a longitudinal insertion force by the container defines a stop position of the printing agent container.

11. A printing agent container receptacle according to claim 10, wherein the stop position is determined by a blocker movable between a first position, wherein the blocker stops the printing agent container at a first distance from the opening, and a second position wherein the printing agent container stops in a position further than the first distance.

12. A printing agent container receptacle according to claim 10 wherein the actuator is located in a position wherein the actuator receives the longitudinal insertion force when the container exceeds a threshold width or height.

13. A printing agent container receptacle according to claim 10 wherein the actuator is located at a threshold width and/or height so that it moves the actuator from the first position to the second position by containers that exceed the threshold width and/or height

14. A printing agent container receptacle according to claim 10, wherein the stop position is defined by an arm movable upon receipt of the longitudinal insertion force with at least a component in the longitudinal direction defined by the insertion force.

15. A 3D printing system comprising a printing agent container receptacle that comprises an input opening to receive a printing agent container in a longitudinal direction wherein the receptacle comprises a blocker movable between:
A first position wherein the blocker stops the printing agent container at a first distance from the opening; and
a second position wherein the printing agent container stops in a position further from the opening than the first distance;
wherein the receptacle further comprises an actuator to move the blocker from the first position to the second position upon receipt of a longitudinal force by insertion of the printing agent container into the printing agent container receptacle.
